(19) United States
(12) Patent Application Publication
(10) Pub. No.: US 2024/0258554 A1
(43) Pub. Date: Aug. 1, 2024

(54) Electrode Assembly, Secondary Battery Including The Same, Method For Manufacturing The Secondary Battery, and Apparatus For Manufacturing The Secondary Battery

(71) Applicant: LG Energy Solution, Ltd., Seoul (KR)

(72) Inventors: Eui Seob Song, Daejeon (KR); Ki Beom Park, Daejeon (KR); Zheng Hua Li, Daejeon (KR); Hyo Joon Lee, Daejeon (KR); Min Ha Yee, Daejeon (KR); Eun Ji Song, Daejeon (KR)

(73) Assignee: LG Energy Solution, Ltd., Seoul (KR)

(21) Appl. No.: 18/561,012

(22) PCT Filed: Sep. 14, 2022
(86) PCT No.: PCT/KR2022/013735

§ 371 Date: Nov. 15, 2023

(30) Foreign Application Priority Data
Sep. 14, 2021 (KR) 10-2021-0122787
Sep. 13, 2022 (KR) 10-2022-0115146

(51) Int. Cl. H01M 10/04; B30B 9/28

(52) U.S. Cl. CPC H01M 10/0431; B30B 9/28; H01M 10/0409

(57) ABSTRACT

The present disclosure provides a method and apparatus for manufacturing a secondary battery. The method includes a manufacturing a unit cell including an electrode and a separator; folding a plurality of unit cells and a separator sheet to be alternately stacked so as to manufacture an electrode assembly; correcting a height difference formed on an outer surface of the electrode assembly; and pressing the electrode assembly, wherein, in the correction step, a correction sheet is disposed on an area formed with a relatively low height with respect to the inside of the electrode assembly to correct the height difference formed on the outer surface of the electrode assembly.

### CROSS-REFERENCE TO RELATED APPLICATIONS

The present application is a national phase entry under 35 U.S.C. § 371 of No. International Application PCT/KR2022/013735 filed on Sep. 14, 2022, which claims priority from Korean Patent Application No. 10-2021-0122787 filed on Sep. 14, 2021 and from Korean Patent Application No. 10-2022-0115146 filed on Sep. 13, 2022, which are hereby incorporated by reference in their entirety.

### TECHNICAL FIELD

The present disclosure relates to an electrode assembly, a secondary battery including the same, a method for manufacturing a secondary battery, which manufactures the same, and an apparatus for manufacturing a secondary battery, which is used therefor, and more particularly, to an electrode assembly, which is capable of improving a non-bonded area of an electrode and a separator inside an electrode unit and a non-bonded area of an electrode unit and a separator sheet inside the electrode assembly, a secondary battery including the same, a method for manufacturing a secondary battery, which manufactures the same, and an apparatus for manufacturing a secondary battery, which is used therefor.

### BACKGROUND ART

Batteries (cells) that generate electric energy through physical or chemical reaction to supply the generated electric energy to the outside are used when AC power to be supplied to the building is not obtained, or DC power is required according to the living environments surrounded by various electric and electronic devices.

Among such batteries generally being used are primary batteries and secondary batteries, which are chemical batteries using chemical reaction. The primary batteries are consumable batteries which are collectively referred to as dry batteries. The secondary batteries are rechargeable batteries that are manufactured by using a material in a redox process between current and a substance that is repeatable several times. When the reduction reaction is performed on the material by the current, power is charged, and when the oxidation reaction is performed on the material, power is discharged. This charging-discharging is repeatedly performed to generate electricity.

Here, in a lithium-ion battery among secondary batteries, an electrode slurry, in which an active material, a conductive material, and a binder are mixed, may be applied at a predetermined thickness to a positive electrode conductive foil and a negative electrode conductive foil to manufacture an electrode, and a separator may be interposed between both the conductive foils to manufacture an electrode assembly.

In addition, the secondary battery may be classified according to a structure of the electrode assembly having a structure of a positive electrode/separator/negative electrode. For example, the secondary batteries may be classified into a cylindrical secondary battery, in which long sheet-type positive and negative electrodes are wound several times in the form of a bulk jelly roll with a separator therebetween to manufacture an electrode assembly, and then, the manufactured electrode assembly is accommodated in a cylindrical can so that the can is sealed, and a pouch-type secondary battery, in which a bi-cell, in which positive and negative electrodes, each of which has a predetermined size, are stacked with a separator therebetween, is folded to manufacture an electrode assembly, and then, the manufactured electrode is accommodated in a pouch so that the pouch is sealed.

When manufacturing the electrode, the electrode slurry is non-uniformly applied to the conductive foils due to viscosity of the electrode slurry, resulting in a difference in coating thickness of the electrode slurry. Particularly, in the pouch-type secondary battery, the difference in coating thickness of the electrode slurry forms a non-bonded area of the electrodes and separator inside a unit cell manufactured by including the electrodes after the electrodes are manufactured and a non-bonded area of a unit cell and a separator sheet of the electrode assembly including the unit cell, resulting in lithium precipitation due to interfacial resistance on the negative electrode to increase in resistance of the electrodes.

### Technical Problem

The present disclosure has been made to solve the above problems, and an object of the present disclosure is to provide an electrode assembly, which is capable of improving a non-bonded area of an electrode and a separator inside an electrode unit and a non-bonded area of an electrode unit and a separator sheet inside the electrode assembly, a secondary battery including the same, a method for manufacturing a secondary battery, which manufactures the same, and an apparatus for manufacturing a secondary battery, which is used therefor.

### Technical Solution

The present disclosure provides a method for manufacturing a secondary battery, the method including: a unit cell manufacturing process of manufacturing a unit cell including an electrode and a separator; an electrode assembly manufacturing process of folding a plurality of unit cells and a separator sheet to be alternately stacked so as to manufacture an electrode assembly; a correction process of correcting a height difference formed on an outer surface of the electrode assembly; and a pressing process of pressing the electrode assembly, wherein, in the correction process, a correction sheet is disposed on an area formed with a relatively low height with respect to the inside of the electrode assembly to correct the height difference formed on the outer surface of the electrode assembly.

In the correction process, the height difference may be corrected so that the outer surface of the electrode assembly has a uniform height.

The electrode assembly may include: a first area having a first height; and a second area having a second height less than the first height, wherein, in the correction process, the correction sheet may be disposed on the second area to correct a height difference between the first area and the second area.

In the correction process, the correction sheet may be disposed on the second area by a difference between the first height and the second height.

The second area may be disposed to correspond to an edge of the electrode assembly.

The electrode assembly may include an electrode tab connected to the electrode, and the second area may be disposed to correspond to an area on which the electrode tab of the electrode assembly is disposed.

The correction sheet may be made of an insulating material.

The correction sheet may include a synthetic resin or an adhesive material.

The correction sheet may include a cast polypropylene tape (CPP) tape.

In addition, the present disclosure may provide an electrode assembly in which a plurality of unit cells, each of which includes an electrode and a separator, and separator sheets are alternately stacked, the electrode assembly including: a first area having a first height; a second area having a second height less than the first height; and a correction sheet disposed on the second area to correct a height difference between the first area and the second area.

The correction sheet may be disposed by the height difference between the first area and the second area.

The second area may be disposed to correspond to an edge of the electrode assembly.

The electrode assembly may include an electrode tab connected to the electrode, and the second area may be disposed to correspond to an area on which the electrode tab of the electrode assembly is disposed.

In addition, the present disclosure may provide a secondary battery including an electrode assembly in which a plurality of unit cells, each of which includes an electrode and a separator, and separator sheets are alternately stacked, wherein the electrode assembly includes: a first area having a first height; a second area having a second height less than the first height; and a correction sheet disposed on the second area to correct a height difference between the first area and the second area.

In addition, the present disclosure may provide an apparatus for manufacturing a secondary battery, which manufactures a secondary battery including an electrode assembly in which a plurality of unit cells, each of which includes an electrode and a separator, and separator sheets are alternately stacked, wherein the electrode assembly includes: a first area having a first height; a second area having a second height less than the first height; and a correction sheet disposed on the second area to correct a height difference between the first area and the second area, and the apparatus for manufacturing the secondary battery includes a pressing press configured to press the electrode assembly, wherein the pressing press is provided so that a pressing surface configured to press the electrode assembly is stepped.

The pressing surface may include: a first pressing surface configured to press the first area; a second pressing surface configured to press the second area; and a connection surface configured to connect the first pressing surface to the second pressing surface, wherein the second pressing surface may protrude further than the first pressing surface toward the electrode assembly.

The connection surface may be disposed to be inclined with respect to the first pressing surface and the second pressing surface.

In addition, the present disclosure may provide a method for manufacturing a secondary battery, the method including: a unit cell manufacturing process of manufacturing a unit cell including an electrode and a separator; an electrode assembly manufacturing process of folding a plurality of unit cells and a separator sheet to be alternately stacked as to manufacture an electrode assembly; a correction process of correcting a height difference formed on an outer surface of the electrode assembly; and a pressing process of pressing the electrode assembly, wherein the pressing process includes: a first pressing process of pressing the electrode assembly using a first pressing press; and a second pressing process of pressing the electrode assembly using a second pressing press, wherein at least one of the first pressing press and the second pressing press is formed so that a pressing surface for pressing the electrode assembly is stepped.

The first pressing press may be formed so that the pressing surface for pressing the electrode assembly is stepped, and the second pressing press may be formed so that the pressing surface for pressing the electrode assembly is flat at a predetermined height.

### Advantageous Effects

The present disclosure may have the advantage of including the correction process of correcting the height difference occurring on the outer surface of the electrode assembly so that the non-bonded area of the electrode and the separator inside the unit cell and the non-bonded area of the unit cell and the separator sheet inside the electrode assembly are pressed in the pressing process to bond the non-boned areas to each other, thereby improving the performance of the secondary battery.

In addition, the present disclosure may have the advantage in that the at least one pressing surface of the pressing press, which presses the electrode assembly, is formed to be stepped so that the non-bonded area of the electrode and the separator inside the unit cell and the non-bonded area of the unit cell and the separator sheet inside the electrode assembly are pressed to bond the non-boned areas to each other, thereby improving the performance of the secondary battery.

### BRIEF DESCRIPTION OF THE DRAWINGS

FIG. 1 is a flowchart illustrating a method for manufacturing a secondary battery according to an embodiment of the present invention.

FIG. 2 is a side view illustrating a side surface of an electrode assembly in which a height difference is corrected according to an embodiment of the present invention.

FIG. 3 is a front view illustrating a front surface of the electrode assembly in which the height difference is corrected according to the embodiment of FIG. 2.

FIG. 4 is a conceptual view illustrating a process of pressing the electrode assembly using a pressing press of an apparatus for manufacturing the secondary battery according to an embodiment of the present invention.

FIG. 5 is an enlarged view of region A in FIG. 4.

FIG. 6 is a flowchart illustrating a pressing process in an embodiment of a method for manufacturing the secondary battery according to the present invention.

FIG. 7 is a conceptual view illustrating a process of pressing the electrode assembly using a first pressing press and a second pressing press in an embodiment of a method for manufacturing the secondary battery according to the present invention.

FIG. 8A is an image illustrating whether a non-bonded area of an electrode and a separator is formed on a unit cell (bi-cell) manufactured according to the related art.

FIG. 8B is an image illustrating whether a non-bonded area of an electrode and a separator is formed on a unit cell (bi-cell) manufactured according to the present disclosure.

### MODE FOR CARRYING OUT THE INVENTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention.

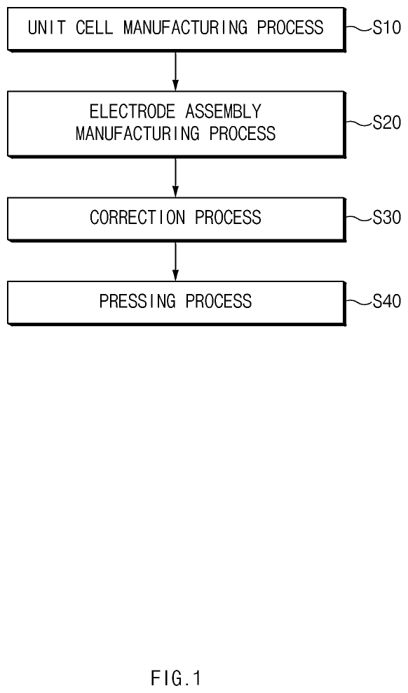

As illustrated in FIG. 1, the present disclosure provides a method for manufacturing a secondary battery, which includes: a unit cell manufacturing process S10 of manufacturing a unit cell including an electrode and a separator; an electrode assembly manufacturing process S20 of folding a plurality of unit cells and separator sheets to be alternately stacked so as to manufacture an electrode assembly; a correction process S30 of correcting a height difference occurring on an outer surface of the electrode assembly; and a pressing process S40 of pressing the electrode assembly.

First, the unit cell manufacturing process S10 may be a process of manufacturing the unit cell including the electrode and the separator and be performed in various manners.

For example, in the unit cell manufacturing process S10, electrode slurry may be applied on an electrode collector (e.g., conductive foil) thereby manufacturing a positive electrode or a negative electrode. Then, the separator may be interposed between the electrodes, and the electrodes and the separator may be pressed to manufacture the unit cell.

However, in the process of manufacturing the electrodes, the electrode slurry may be applied on only a partial area on the electrode collector. Thus, a difference in thickness between an area, on which the electrode slurry is uniformly applied, and the applied electrode slurry may occur on the partial area on which the electrode slurry is non-uniformly applied. Particularly, when a smaller amount of electrode slurry is applied to the area, on which the electrode slurry is non-uniformly applied, rather than the surrounding uniformly applied area, an empty space may be formed between the electrode and the separator, resulting in the non-bonded area.

After the unit cell manufacturing process S10, as illustrated in FIG. 1, the electrode assembly manufacturing process S20 of manufacturing the electrode assembly 10 including the unit cell may be performed.

Here, the electrode assembly manufacturing process S20 may be a process of manufacturing the electrode assembly by folding the plurality of unit cells and separator sheets so as to be alternately stacked and may be performed in various manners.

Specifically, in the electrode assembly manufacturing process S20, the unit cells manufactured in the above-described unit cell manufacturing process S10 may be disposed side by side on the separator sheet. The unit cells and the separator sheets, which are formed with surfaces having surface areas and shapes corresponding to each other, may be disposed to be alternately stacked. The separator sheets may be folded several times in a direction in which the separator sheets surround the unit cell disposed on the separator sheets to manufacture the electrode assembly 10. An outer surface of the electrode assembly 10 manufactured as described above may be formed in a shape in which the separator sheet surrounds the electrode assembly 10. That is, since the unit cell and the separator sheet are formed to have the surface areas and shape corresponding to each other, the outer surface of the manufactured electrode assembly 10 may not expose the electrode portion of the unit cell and may be completely wrapped with the separator sheet to protect the unit cell disposed inside the separator sheet.

However, the electrode slurry may be non-uniformly applied on the partial area between the electrode and the separator. In this case, the difference in coating thickness of the electrode slurry may occur between the uniformly applied surrounding area and the non-uniformly applied area, resulting in the non-bonded area between the electrode and the separator. In the case of the unit cell having the non-bonded area, a specific area of the unit cell may have a relatively low height compared to each of the other areas by the difference in coating thickness of the electrode slurry. Thus, when the electrode assembly 10 is manufactured, if the unit cells are disposed to be stacked in parallel in one direction, a non-bonded area may be formed again between the unit cell and the separator sheet by the non-bonded area formed in the unit cell. Then, when the separator sheet is folded several times, the non-bonded areas may be accumulated, and thus, a specific area of the electrode assembly 10 may have a relatively low height compared to each of other areas.

Specifically, the electrode assembly 10 may have a height difference formed on the outer surface so that the outer surface is formed to be stepped in a stair shape, or the outer surface is formed to be inclined with a predetermined inclination.

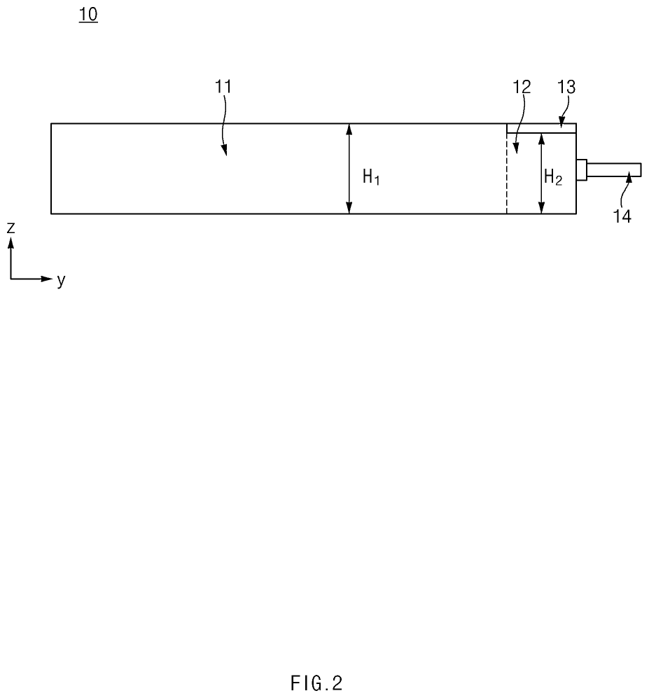

In this case, as illustrated in FIG. 2, the electrode assembly 10 may include a first area 11 having a first height H1; and a second area 12 having a second height H2 lower than the first height H1. However, dotted lines disposed between the first area 11 and the second area 12 in FIG. 2 are shown to better understand positions of the first area 11 and the second area 12, and thus, it does not mean that an internal area of the electrode assembly 10 is divided.

Specifically, the first area 11 means an area having the first height H1 in the electrode assembly 10.

Here, the first height H1 may be defined as a height formed with the highest height from a first surface of the electrode assembly 10 disposed in the stacking direction of the unit cells to a second surface facing the first surface. Thus, the first area 11 may be understood as an area having the greatest thickness in the electrode assembly 10.

The second area 12 means an area having the second height H2 lower than the first height H1 in the electrode assembly 10. A height difference between the second height H2 and the first height H1 may be formed to be accumulated while the non-bonded area between the electrode and the separator, which occurs by the difference in coating thickness of the electrode slurry applied to the electrode in the unit cell, and the non-bonded area formed by alternately stacking the unit cell and the separator sheet are folded several times.

Here, the second height H2 may be defined as a height formed so that a height from a first surface of the electrode assembly 10 disposed in the stacking direction of the unit cells to a second surface facing the first surface is lower than the first height H1. Thus, the second area 12 may be understood as all areas having a thickness less than that of the first area 11 in the electrode assembly 10.

Also, the second area 12 may be disposed at any portion on the electrode assembly 10.

For example, as a length of the electrode collector increases, the electrode slurry may be less likely to reach an edge of the electrode collector when the electrode slurry is applied. Thus, the second area 12 may be disposed to correspond to an edge of the electrode assembly 10.

Particularly, the second area 12 may be disposed to correspond to the edge area of the electrode assembly 10 on which the electrode tab 14 is disposed on the edge area of the electrode assembly 10.

In the case of manufacturing two electrodes by applying and drying the electrode slurry to a central portion of one electrode collector to cut the electrode collector during the electrode manufacturing, it may be expected that the electrode slurry is sufficiently applied to an edge area of the electrode assembly 10, which originally corresponds to the central portion of the electrode current collector. However, it may be understood that the edge area of the electrode assembly 10, on which the electrode tab 14 is disposed, is easily allows the electrode slurry to be relatively reached. That is, while the electrode slurry reaches the edge area, the coating thickness of the electrode slurry may become thinner, and the second area 12 may be formed.

Here, the electrode tab 14 may be formed on the electrode collector through a notching process before the electrode slurry is applied or may be attached to any portion of the electrode collector after the electrode slurry is applied so as to be connected to the electrode.

The correction process S30 of correcting the height difference formed on the outer surface of the electrode assembly 10 so that the outer surface of the electrode assembly 10 is uniformly pressed in the pressing process S40 to be described later after the electrode assembly manufacturing process S20 may be additionally performed.

That is, as the height difference of the outer surface of the electrode assembly 10 is corrected through the correction process S30, not only the first area 11 having a relatively high height, but also the second area 12 having a relatively low height in the electrode assembly 10 may be pressed in the pressing process S40 described below. Thus, the non-bonded area of the electrode and the separator, which is disposed on the second area 12, and the non-bonded area of the unit cell and the separator sheet may be improved.

Specifically, the correcting process S30 may be a process of correcting the height difference formed on the outer surface of the electrode assembly 10 by disposing a correction sheet 13 on an area of the electrode assembly 10, which is formed with a relatively low height and may be performed in various manners.

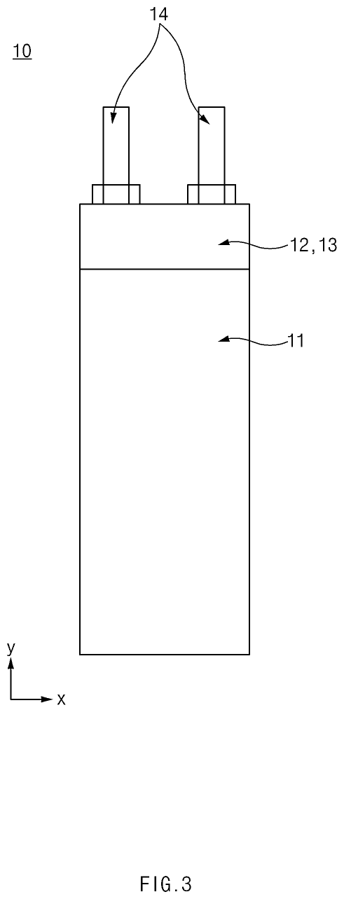

For example, in the correction process S30, as illustrated in FIGS. 2 and 3, the correction sheet 13 may be disposed at an upper side of the separator sheet on the second area 12 having the relatively low height in the electrode assembly 10 to correct the height difference H1-H2 between the first area 11 and the second area 12. The electrode assembly 10 may be provided to have areas and shapes corresponding to each other to manufacture the electrode assembly 10, and since the outer surface of the manufactured electrode assembly 10 is wrapped by the separator sheet, the correction sheet 13 may be provided and attached at the upper side of the separator sheet on the second area 12. In FIG. 3, reference numerals 12 and 13 are shown to indicate the same position, but since the correction sheet 13 is additionally disposed on the second area 12, it is noted that, in the present disclosure, the second area 12 and the correction sheet 13 are distinct concepts. In addition, a solid line disposed between the first area 11 and the second area 12 in FIG. 3 is shown to distinguish the correction sheet 13 additionally disposed on the first area 11 and the second area 12 and does not mean that the internal area of the electrode assembly 10 is divided.

Here, the correction sheet 13 may be stacked in various ways to reduce the height difference H1-H2 between the first area 11 and the second area 12.

For example, at least one correction sheet 13 may be stacked and disposed according to the thickness of the correction sheet 13 and the height difference H1-H2 between the first area 11 and the second area 12.

Here, the correction sheet 13 may be disposed at the upper side of the separator sheet on the second area 12 by as much as the height difference H1-H2 between the first height H1 and the second height H2 so that the height of the outer surface of the electrode assembly 10 is uniform.

The correction sheet 13 may be made of various materials. For example, the correction sheet 13 may be made of any material as long as it does not affect the performance of the electrode assembly and may include, for example, a synthetic resin or an adhesive material.

In addition, a tape made of an insulating material may be used for the correction sheet 13, and for example, a CPP tape (cast polypropylene tape) used for insulating an electrode tab in the related art may be used.

In addition, the correction sheet 13 may have various widths and thicknesses, and for example, the correction sheet 13 may have a width of 12 mm and a thickness of 0.03 mm.

After the correction process S30 is performed, the pressing process S40 of pressing the electrode assembly 10 to bond the unit cell and the separator sheet of the electrode assembly 10 to each other is performed.

Here, the pressing process S40 may be a process of pressing the electrode assembly 10 and may be performed in various manners.

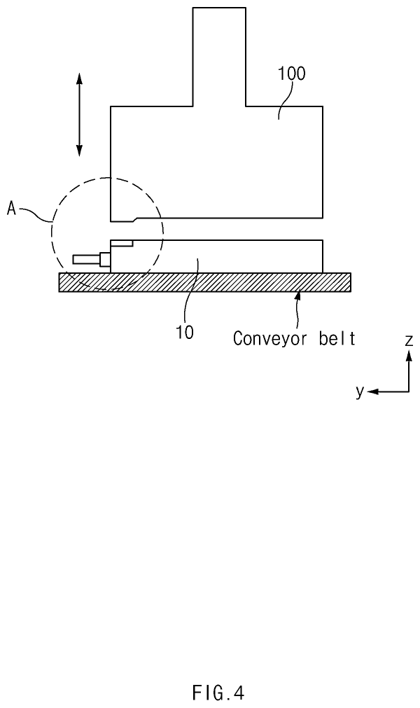

For example, as illustrated in FIG. 4, the pressing process S40 may be performed using an apparatus for manufacturing the secondary battery, which includes a pressing press 100 for pressing the electrode assembly 10 moving on a conveyor belt. Here, the electrode assembly 10 may move on the conveyor belt in an x direction (a direction penetrating the drawing) perpendicular to a y-z plane of the drawing.

Here, the pressing press 100 may be a configuration that presses the electrode assembly 10 and may have various configurations.

For example, as described above, the pressing press 100 may have a pressing surface 110 formed to be stepped so as to correspond to the height difference formed on the outer surface of the electrode assembly 10 so that the pressing press 100 presses the outer surface of the electrode assembly 10 as uniformly as possible even when the height difference is formed on the outer surface of the electrode assembly 10.

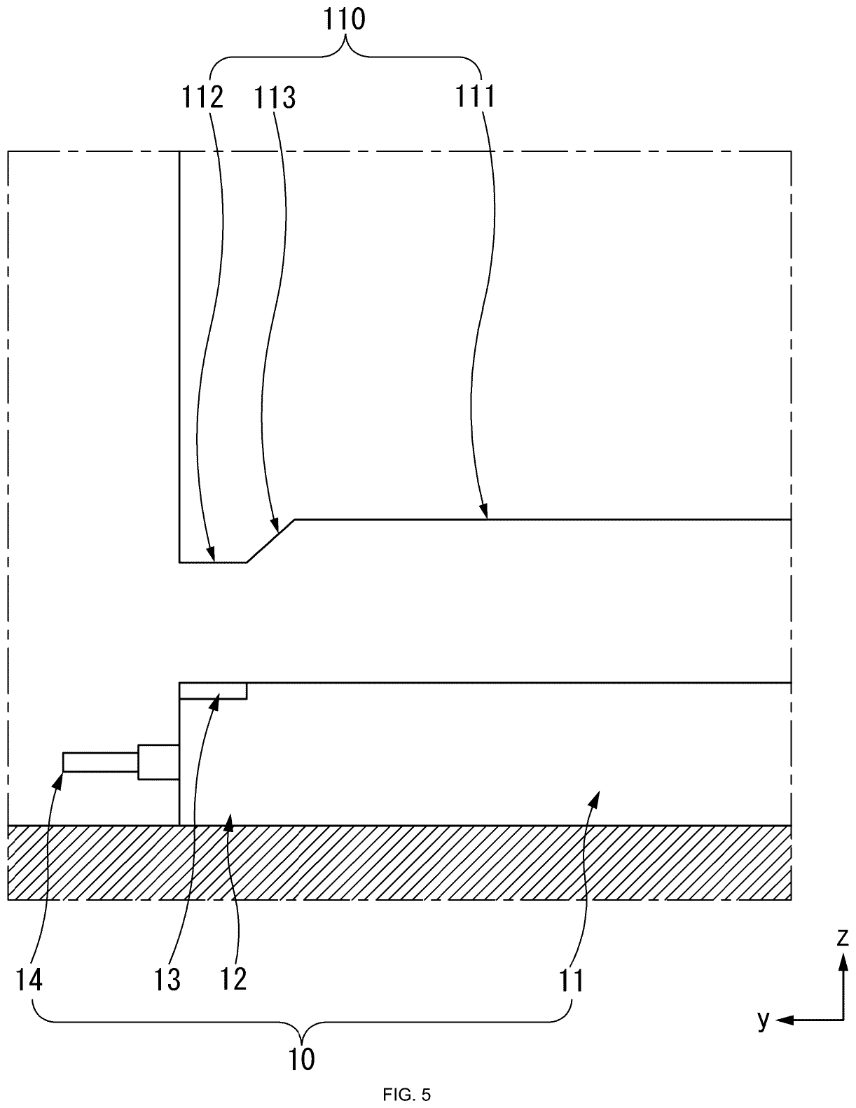

Particularly, as illustrated in FIG. 5, the pressing surface 110 includes: a first pressing surface 111 formed on a lower portion of the pressing press 100 to press the first area 11; a second pressing surface 112 pressing the second area 12; and a connection surface 113 connecting the first pressing surface 111 to the second pressing surface 112.

The first pressing surface 111 may be a pressing surface that presses the first area 11 and may have various configurations. For example, the first pressing surface 111 may have any shape as long as the first pressing surface 111 is capable of pressing the first area 11.

The second pressing surface 112 may be a pressing surface that presses the second area 12 and may have various configurations. For example, the second pressing surface 112 may have any shape as long as it can press the second area 12.

Here, the second pressing surface 112 may be formed to protrude more than the first pressing surface 111 toward the electrode assembly 10.

That is, the first pressing surface 111 and the second pressing surface 112 may be formed to be stepped with respect to each other. Here, the second pressing surface 112 may protrude from the first pressing surface 111 by the height difference H1-H2 between the first area 11 and the second area 12 of the electrode assembly 10.

Thus, when the pressing press 100 presses the electrode assembly 10, the electrode assembly 10 may uniformly press one surface on which the first area 11 and the second area 12 are formed in spite of the height difference between the first area 11 and the second area 12 of the outer surface of the electrode assembly 10.

The connection surface 113 may be a configuration connecting the first pressing surface 111 to the second pressing surface 112 and may have various configurations.

Specifically, the connection surface 113 may be disposed between the first pressing surface 111 and the second pressing surface 112 to connect the first pressing surface 111 and the second pressing surface 112, which have heights different from one another.

Here, the connection surface 113 may be connected to the first pressing surface 111 and the second pressing surface 112 in various manners.

For example, as illustrated in FIG. 5, the connection surface 113 may be connected to be inclined with respect to the first pressing surface 111 and the second pressing surface 112 so as to minimize damage caused by linear scratches and damage on the electrode surface.

In addition, the pressing press 100 may include a heating member (not shown) heated to a temperature higher than room temperature to thermally press the electrode assembly 10.

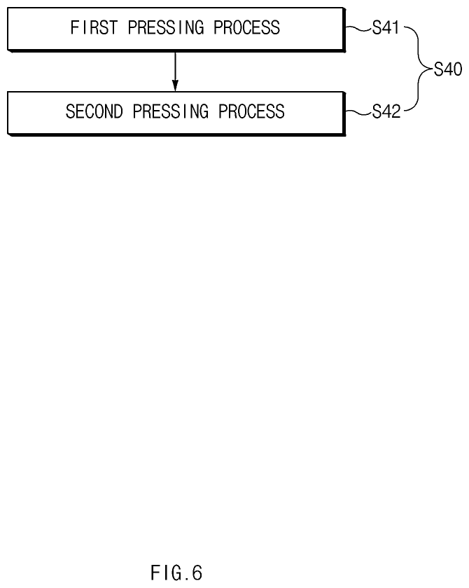

As illustrated in FIG. 6, the pressing process S40 may include a first pressing process S41 of pressing the electrode assembly using a first pressing press; and a second pressing process S42 of pressing the electrode assembly by using a second pressing press.

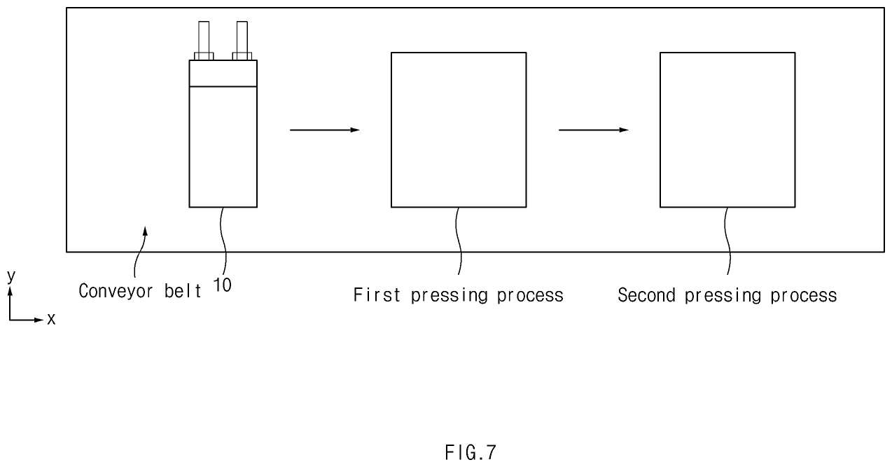

That is, in the pressing process S40, as illustrated in FIG. 7, the first pressing press and the second pressing press may be sequentially disposed along the moving direction of the electrode assembly 10 on the conveyor belt to press the above-described electrode assembly at least twice. Here, the first pressing press and the second pressing press may press the electrode assembly 10 by moving in a z direction (direction penetrating the drawing) perpendicular to the x-y plane on the drawing.

Here, as described above, at least one of the first pressing press and the second pressing press may include the pressing press 100 having the stepped pressing surface 110 for pressing the electrode assembly 10. Here, contents of the pressing press 100 may be cited from the above contents.

For example, in the first pressing press, the pressing surfaces 110 for pressing the electrode assembly 10 may be formed to be stepped so as to have different heights; and the pressing surface of the second pressing press may be formed to be flat at a predetermined height.

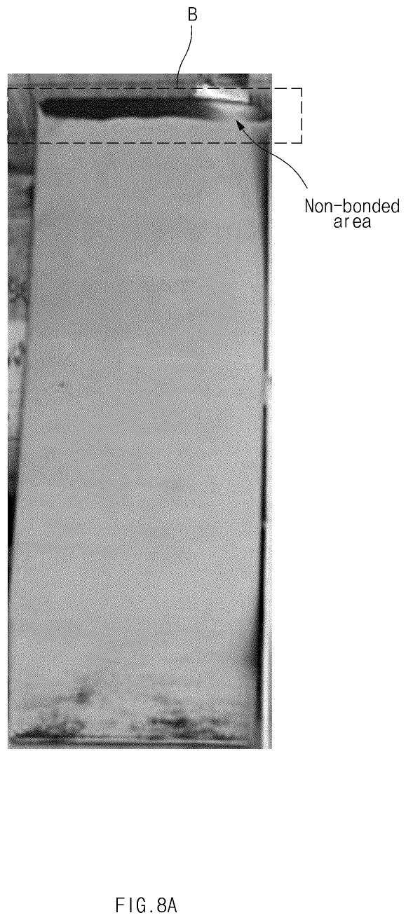

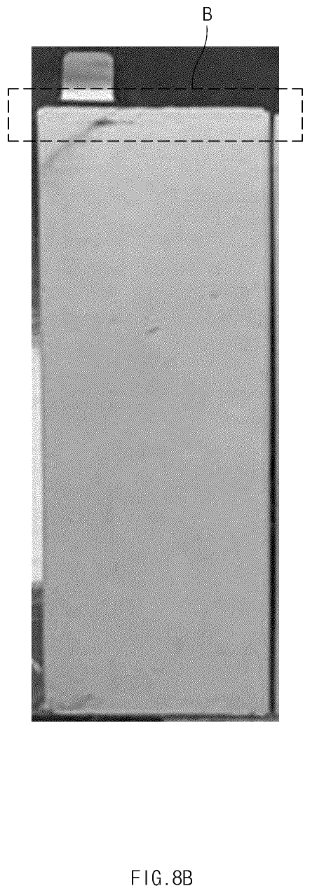

Hereinafter, a size of the non-bonded area of the electrode and the separator of the unit cell according to whether the present disclosure is applied will be described with reference to FIGS. 8A_B. FIG. 8A illustrates a front image (hereinafter, reference to as ‘Comparative Example’) of a unit cell (bi-cell) manufactured according to the related art. FIG. 8B illustrates a front image (hereinafter, referred to as an ‘embodiment of the present disclosure’) of a unit cell (bi-cell) manufactured according to the present disclosure.

First, referring to the front image of the unit cell, which is formed by Comparative Example in FIG. 8A, it is seen that an non-bonded area of an electrode and a separator, which has a black color, is formed on an edge portion B corresponding to an upper portion of a unit cell, i.e., an electrode tab. In addition, in the case of an electrode assembly including the unit cell as described above, it is expected that a non-bonded area between the unit cell and a separator sheet occurs. Thus, lithium is precipitated on a negative electrode to increase in resistance of the electrode, and a problem in which performance of the secondary battery is deteriorated may occur.

On the other hand, referring to the front image of the unit cell formed according to the embodiment of the present disclosure in FIG. 8B, it is seen that almost no non-bonded area is formed on an upper portion of the unit cell, i.e., an edge portion B corresponding to an electrode tab. Therefore, it is expected that the unit cell formed according to an embodiment of the present disclosure will hardly form not only the non-bonded area of the electrode and the separator inside the unit cell, but also the non-bonded area between the unit cell and the separator sheet on the electrode assembly. Thus, there may be an advantage in that the performance of the secondary battery is improved by minimizing the lithium precipitation on the negative electrode due to interfacial resistance.

While the embodiments of the present disclosure have been described with reference to the specific embodiments, it will be apparent to those skilled in the art that various changes and modifications may be made without departing from the spirit and scope of the invention as defined in the following claims.

### DESCRIPTION OF THE SYMBOLS

10: Electrode assembly
11: First area
12: Second area
13: Correction sheet
14: Electrode tab
100: Pressing press
110: Pressing surface
111: First pressing surface
112: Second pressing surface
113: Connection surface
S10: Unit cell manufacturing process
S20: Electrode assembly manufacturing process
S30: Correction process
S40: Pressing process
S41: First pressing process
S42: Second pressing process

1. A method for manufacturing a secondary battery, the method comprising:
manufacturing a plurality of unit cells, each unit cell including an electrode and a separator, respectively;
folding the plurality of unit cells and a separator sheet alternately stacked with one another to manufacture an electrode assembly;
correcting a height difference formed on an outer surface of the electrode assembly; and
pressing the electrode assembly,
wherein, in the correcting step, a correction sheet is disposed on an area formed with a relatively low height with respect to the inside of the electrode assembly to correct the height difference formed on the outer surface of the electrode assembly.

2. The method of claim 1, wherein, in the correcting step, the height difference is corrected so that the outer surface of the electrode assembly has a uniform height.

3. The method of claim 1, wherein the electrode assembly comprises:
a first area having a first height; and
a second area having a second height less than the first height,
wherein, in the correcting step, the correction sheet is disposed on the second area to correct the height difference between the first area and the second area.

4. (canceled)

5. The method of claim 3, wherein the second area is disposed to extends to an edge of the electrode assembly.

6. The method of claim 3, wherein the electrode assembly comprises an electrode tab connected to the electrode, and
the second area is disposed to align with an area on which the electrode tab of the electrode assembly is disposed.

7. The method of claim 1, wherein the correction sheet is made of an insulating material.

8. The method of claim 1, wherein the correction sheet comprises a synthetic resin or an adhesive material.

9. The method of claim 8, wherein the correction sheet comprises a cast polypropylene tape (CPP) tape.

10. The method of claim 1, wherein an electrode slurry is applied on the electrode, and
the height difference is formed by a thickness difference of the applied electrode slurry.

11. The method of claim 1, wherein the unit cell and the separator sheet each have a respective first surface, the first surfaces of the unit cell and the separator sheet having corresponding surface areas.

12. The method of claim 1, wherein the correction sheet is disposed above the separator sheet.

13. An electrode assembly comprising:
a plurality of unit cells, each of which comprises an electrode and a separator; separator sheets alternately stacked with the plurality of unit cells;
a first area having a first height;
a second area having a second height less than the first height so as to define a height difference between the first area and the second area; and
a correction sheet disposed on the second area to correct the height difference.

14. (canceled)

15. The electrode assembly of claim 13, wherein the second area is disposed to extends to an edge of the electrode assembly.

16. The electrode assembly of claim 13, wherein the electrode assembly comprises an electrode tab connected to the electrode, and
the second area is disposed to align with an area on which the electrode tab of the electrode assembly is disposed.

17. The electrode assembly of claim 13, wherein an electrode slurry is applied to the electrode, and
the height difference is formed by a thickness difference of the applied electrode slurry.

18. The electrode assembly of claim 13, wherein the unit cell and the separator sheet each have a respective first surface, the first surfaces of the unit cell and the separator sheet having corresponding surface areas.

19. The electrode assembly of claim 13, wherein the correction sheet is provided above the separator sheet.

20. A secondary battery comprising:
the electrode assembly of claim 13.

21. An apparatus for manufacturing a secondary battery, comprising:
a pressing press configured to press an electrode assembly, the electrode assembly including a plurality of unit cells alternately stacked with at least one separator sheet, the electrode assembly including a first area having a first height and a second area having a second height less than the first height, and the electrode assembly including a correction sheet disposed on the second area,
wherein the pressing press includes a pressing surface configured to press the electrode assembly, the pressing surface including a step.

22. The apparatus of claim 21, wherein the pressing surface comprises:
a first pressing surface configured to press the first arca;
a second pressing surface configured to press the second area; and
a connection surface configured to connect the first pressing surface to the second pressing surface,
wherein the second pressing surface protrudes further than the first pressing surface toward the electrode assembly when the electrode assembly is positioned in the apparatus.

23. The apparatus of claim 22, wherein the connection surface is inclined with respect to the first pressing surface and the second pressing surface.

24. The apparatus of claim 21, wherein an electrode slurry is applied on the electrode assembly, and
a height difference between the first height and the second height is formed by a thickness difference of the applied electrode slurry.

25. The apparatus of claim 21, wherein the unit cell and the separator sheet each have a respective first surface, the first surfaces of the unit cell and the separator sheet having corresponding surface areas.

26. The apparatus of claim 21, wherein the correction sheet is provided above the separator sheet.

27. A method for manufacturing a secondary battery, the method comprising:
manufacturing a plurality of unit cells, each unit cell including an electrode and a separator, respectively;
folding the plurality of unit cells and a separator sheet to be alternately stacked with one another to manufacture an electrode assembly;
correcting a height difference formed on an outer surface of the electrode assembly; and
pressing the electrode assembly,
wherein the pressing step comprises:
a first pressing process of pressing the electrode assembly using a first pressing surface; and
a second pressing process of pressing the electrode assembly using a second pressing surface,
wherein at least one of the first pressing surface the second pressing surface includes a step there along.

28. The method of claim 27, wherein the step is positioned on the first pressing, and
the second pressing surface is flat at a predetermined height.
